(19) United States
(12) Patent Application Publication
(10) Pub. No.: US 2008/0131354 A1
(43) Pub. Date: Jun. 5, 2008

(54) Polyaluminum calcium hydroxychlorides and methods of making the same

(75) Inventors: Zijun Li, Westfield, NJ (US); Kevin Janak, Ossining, NY (US); Mark Rerek, Sooth Plains, NJ (US)

Correspondence Address: ARTHUR J. PLANTAMURA, ESQ.;GENERAL CHEMICAL PERFORMANCE PRODUCTS LLC., 90 EAST HALSEY ROAD, PARSIPPANY, NJ, 07054, US

(73) Assignee: Reheis, Inc.

(21) Appl. No.: 11/633,998

(22) Filed: Dec. 5, 2006

(51) Int. Cl. C01B 9/02

(52) U.S. Cl. 423/463

(57) ABSTRACT

A process is provided for the preparation of a novel polyaluminum calcium hydroxychloride composition of enhanced efficiency for water treatment, paper sizing, and antiperspirant applications. The polyaluminum calcium hydroxychloride compositions are prepared via the acidification of higher basicity reaction products to form mid-to-high basicity final products. Two methods are provided for the preparation of higher basicity products, contemplated in the first, and an aqueous acid solution, such as hydrochloric acid, aluminum chloride, or a mixture thereof, is mixed with a strong alkaline calcium salt such as calcium oxide or calcium carbonate and aluminum powder at temperatures greater than 60° C. In a second method, bauxite, aluminum hydrate, or aluminum metal, and calcium aluminate are mixed with hydrochloric acid and are reacted at high temperatures and/or elevated pressures for a certain period of time whereby, when the reaction is complete, the mixtures are filtered to obtain clear solutions. The final PAC-Ca solutions may be dried to powder to have a wide range of basicities from about 40% to about 80%. At lower basicities, the polyaluminum calcium hydroxychloride sales are used preferably as antiperspirants, while at higher basicities, the solutions are used preferably as water treatment chemicals.

### FIELD OF THE INVENTION

This invention relates to novel polyaluminum calcium hydroxychloride compositions and to the processes for the preparation of the compositions useful as coagulants for water treatment, paper sizing applications; and antiperspirant actives. The polyaluminum calcium hydroxychloride compositions contemplated by the invention comprise both large polymeric and small monomeric aluminum species, as determined by SEC (size exclusion chromatography)-HPLC (high performance liquid chromatography). These polymeric and monomeric aluminum species are described as Band I and Band IV materials, and are obtained via the acidification of the reaction products formed by high temperature reactions of (1) an aluminum source and an aqueous acidic aluminum solutions and (2) basic calcium salts such as calcium oxide, calcium carbonate, and calcium aluminate. The aluminum source includes aluminum metal, aluminum hydroxyide/oxide, or bauxite but is not limited thereto. The solution reaction products exhibit excellent long term stability and span a wide range of basicities.

### BACKGROUND OF THE INVENTION

Aluminum containing inorganic reagents such as alum (Al₂(SO₄)₃), polyaluminum hydroxychlorides (PAC), and polyaluminum hydroxychlorosulfates (PACS) are commonly used as flocculents and coagulants in municipal and industrial water and wastewater treatment. Although typically more expensive to manufacture than alum, PAC and PACS products are frequently found to work better than alum with regard to floc settling rates, cold water performance, and water pH adjustment. PAC products are typically described by the empirical formula:

Alₙ(OH)₃ₙ₋ₘClₘ

where n is the moles of aluminum, and m is the moles of chloride in the product. The corresponding basicity of the product is defined as % Basicity={[OH⁻]/(3[Al³⁺])}×100, with the basicity calculated as the ratio [(3n−m)/3n]×100. When an alkali metal base or an alkali earth metal base is used to adjust the final basicity of the PAC product, the empirical formula of the product is amended to the following:

Alₙ(OH)_{3n+Zx-m}ClₘYₓ

where n is the moles of aluminum, m is the moles of chloride, x is the moles of alkali metal or alkali earth metal and Z is the valence of the metal (e.g., 1 for Na⁺ and 2 for Ca²⁺). The basicity of the product is typically adjusted in order to account for desired stability, performance, and/or other product characteristics, with the basicity calculated as the ratio [(3n+Zx−m)/3n]×100. In addition, PAC products are characterized by aluminum polymers that comprise a wide spectrum of polymerizations, with values ranging from the ˜1,000 Dalton Al₁₃-mer Keggin-type complex (as disclosed, for example, in U.S. Pat. Nos. 5,985,234 and 5,997,838) to average molecular weight values of 7,000-35,000 Daltons as disclosed in U.S. Pat. No. 5,171,453.

PAC chemicals can be prepared in several ways, including partial neutralization and hydrolysis of aluminum chloride with aluminum hydroxide, aluminum metal, sodium aluminate, calcium aluminate, as well as with a non-aluminum base such as sodium hydroxide, sodium carbonate, sodium bicarbonate, calcium carbonate, calcium hydroxide, and calcium oxide. See, for example, the Ind. Eng. Chem. Res. 2004, 43, 12-17 article describing the preparation of a PAC by reacting AlCl₃ with NaOH through a membrane reactor. Permeation of NaOH through the micropores of an ultrafiltration membrane into AlCl₃ solution reduces the added NaOH droplets to nanoscale size, resulting in a significant reduction of the local base concentration/supersaturation of the added NaOH. This reduction of supersaturation reduces precipitation of material from solution. In addition, as noted in that article, the process results in the formation of significant amounts of the Al₁₃-mer Keggin-type complex, as determined from a ferron time colorimetric assay and, as previously described, an Al_{b}-type species. That article and other prior art (see, for example the above noted, U.S. Pat. Nos. 5,985,234 and 5,997,838), indicate that the Al₁₃ (Al_{b}) species is the most efficient species of PAC because of its high cationic charge of +7 and stability.

PAC solutions are also prepared by reacting aluminum oxide/hydroxide with aluminum chloride or hydrochloric acid at an elevated temperature and pressure. U.S. Pat. No. 5,182,094, for example, discloses a process of making PAC solutions by reacting stoichiometric amount of aluminum hydroxide with aluminum chloride solution at temperatures of 120° C. to 170° C. and an elevated pressure of up to 7 atmospheres. As disclosed therein, at least one of calcium oxide, calcium hydroxide and calcium carbonate can be added to adjust the molar ratio, of hydroxide to aluminum of the resulting PAC solution, to 1.9. That reference is absent any whereby a PAC solution containing calcium is prepared.

The preparation of PAC and PACS solutions containing alkali and alkali earth metals has also been described. See for example, U.S. Pat. No. 5,904,856 relating to a process for the preparation of PAC solutions containing calcium by dissolving calcium aluminate (originally prepared by sintering aluminum hydroxide and calcium oxide or calcium carbonate at 1000° C. to 1400° C.) in HCl solution at 10° C.

U.S. Pat. Nos. 5,985,234 and 5,997,838, disclose a process whereby aluminum oxide trihydrate is reacted with hydrochloric acid and sulfuric acid at elevated temperature (115° C.) to form a polyaluminum hydroxychlorosulfate product which can be subsequently reacted with sodium aluminate under high shear mixing (˜1,000 Hz) at temperatures below 60° C. to produce a PACS of 50%-70% basicity and, at temperatures above 60° C., to produce products of greater than 70% basicity. The high shear mixing operation involved in the preparation is a necessary step of the reaction process. Typically, PAC solutions are unstable at 30% to 75% basicity, forming a precipitate over time. For this reason these references disclose that a small amount of an alkaline-earth metal compound, e.g., up to about 1% calcium carbonate, can be added to the PAC and PACS solutions to be used as a stabilizer for basicities less than 70%. Calcium carbonate is not required for use at basicities greater than 70%, although the stability of the solution is not adversely affected if it is included.

Compositions comprising PACS solutions containing calcium have been noted in U.S. Pat. Nos. 5,348,721 and 5,348,721. All compositions disclosed therein contain sulfate.

Polyaluminum calcium hydroxychloride solutions (PAC-Ca) containing amino acids are also known as antiperspirants of enhanced efficacy as described in U.S. Pat. Nos. 6,042,816 and 7,087,220. Also known is use of polyaluminum hydroxychlorides as antiperspirants. These composition comprising solutions and powders are characterized by SEC-HPLC for the distribution of aluminum species. The aluminum species are separated according to their molecular weights, and described as Bands I, II, III, and IV in order of decreasing molecular weight: Band I has the largest molecular weight aluminum species, the intermediate molecular weight aluminum species are described as Bands II and III, and Band IV contains the aluminum species having the lowest molecular weight, such as aluminum monomers and dimers. The enhanced efficacy of the antiperspirant salts described in U.S. Pat. Nos. 6,042,816 and 7,087,220 is attributed to the presence of both the calcium cation and the amino acid in the polyaluminum hydroxychloride solutions, a combination that activates and stabilizes low molecular weight aluminum species as characterized by high Band III peak area in SEC-HPLC analysis. One skilled in the art, recognize that these Band III polymers are related to enhanced antiperspirant efficacy and typically characterized by low Al_{b} content, as determined by ferron analysis.

Polyaluminum calcium hydroxychloride solutions useful as antiperspirants can also be prepared by the methods described in U.S. Pat. No. 2,571,030, which discloses calcium polyaluminum hydroxychloride antiperspirant salts without amino acids, as salts that are regarded as less corrosive towards fabric damage. That patent describes a process whereby calcium carbonate is reacted with polyaluminum hydroxychloride or with aluminum chloride and aluminum powder; the polyaluminum calcium hydroxychloride salts have 0.2 to 15 parts of calcium for every 100 parts of aluminum by weight. The aluminum species formed are mostly large aluminum polymers with very low amount of aluminum monomers. U.S. Pat. Nos. 3,979,510 and 3,998,788 describe aluminum-zirconium antiperspirant compositions buffered with trace amount of magnesium and calcium carbonate or their glycinate salts and comprise compositions that are regarded as not relevant to the current application.

None of the prior art, referenced above, however, discloses polyaluminum calcium hydroxychloride compositions comprising both large polymeric (Band I) and small monomeric aluminum species (Band IV), as determined by SEC-HPLC. Accordingly, the provision of a stable, economical polyaluminum calcium hydroxychloride compositions comprising both large polymeric and small monomeric aluminum species such that the solutions thereof are useful as efficient water treatment chemicals, paper sizing chemicals, and in antiperspirants formulations, would be highly advantageous.

### SUMMARY OF THE INVENTION

The present invention provides a process for the preparation of novel polyaluminum calcium hydroxychloride compositions of enhanced efficiency the solutions of which are useful for water treatment, paper sizing, and antiperspirant applications. The novel polyaluminum calcium hydroxychloride compositions contemplated by the invention are prepared via the acidification of higher basicity reaction products to form mid- to high basicity final products. In accordance with the invention, alternative methods are provided for the preparation of higher basicity products, hereinafter referred to for convenience as methods A and B.

In Method A, an aqueous acid solution, such as hydrochloric acid, aluminum chloride (AlCl₃), or a mixture thereof, is mixed with a strong alkaline calcium salt such as calcium oxide or calcium carbonate and aluminum powder at temperatures greater than 60° C.

In Method B, bauxite, aluminum hydrate, or aluminum metal, and calcium aluminate are mixed with hydrochloric acid and are reacted at high temperatures and/or elevated pressures for a specified period of time whereby, when the reaction is complete, the mixtures are filtered to obtain clear solutions.

The final PAC-Ca solutions may be dried to powders and can have a wide range of basicities from about 40% to about 80%. At lower basicities, the polyaluminum calcium hydroxychloride salts are used preferably as antiperspirants, while at higher basicities, the solutions are used preferably as water treatment chemicals.

It is accordingly an object of the present invention to provide novel polyaluminum calcium hydroxychloride stable compositions: that are useful as antiperspirant actives and are useful alternatively as water treatment coagulants; that exclude the presence of sulfates; and that settle quickly, and reduce sludge generation in the water treatment process.

It is another object of this invention to provide novel polyaluminum calcium hydroxychloride compositions that are both economical and stable as solutions and that function effectively as water treatment agents and as antiperspirant actives.

### BRIEF DESCRIPTION OF THE DRAWINGS

FIG. 1 is an ²⁷Al NMR of a PAC-Ca solution prepared according to Method A of the invention.

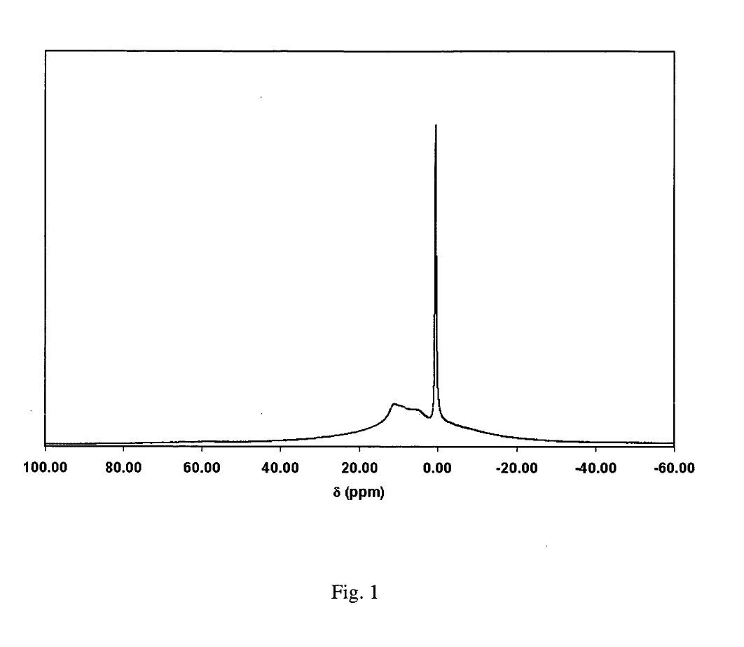

FIG. 2 is the SEC-HPLC of a PAC-Ca solution prepared according to Method B of the invention.

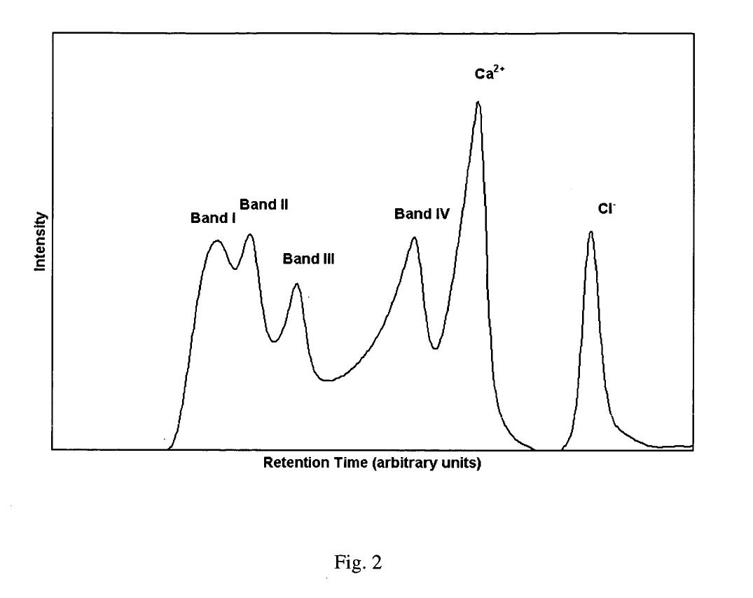

### DETAILED DESCRIPTION OF THE INVENTION

The present invention is directed to the preparation of novel polyaluminum calcium hydroxychloride (PAC-Ca) compositions of enhanced efficiency when used for water treatment, for paper sizing and as antiperspirant applications. The compositions comprise both large polymeric and small monomeric aluminum molecule species obtained through the acidification of products formed by the reactions of aqueous acid solutions and basic calcium salts such as calcium oxide, calcium carbonate, and an aluminum source such as calcium aluminate, aluminum metal, aluminum hydroxide, or bauxite at temperatures above 60° C.

The novel PAC-Ca compositions have the formula:

AlₙCaₓ(OH)_{3n+2χ-m}Clₘ

wherein n is the mole of aluminum, χ is the mole of calcium and m is the mole of chloride. The preferred ratio of aluminum to chloride of the solution is from 0.5 to 1.0 with basicities ranging from about 40% to about 80%.

The invention involves the acidification of the reaction products produced by the alternative methods referred to as Method A and Method B. According to Method A, an aqueous acid solution such as hydrochloric acid or aluminum chloride is first reacted with a strong calcium base such as calcium oxide, calcium hydroxide, or calcium carbonate, followed by reaction of this solution with an aluminum source at temperatures greater than 60° C. The aluminum source can be aluminum powder, pellet, or ingot, aluminum hydroxide or hydrate, as well as bauxite, with aluminum powder being the most preferred. When aluminum powder is used, the reaction temperature in Method A does not have a significant effect on the performance of the final products as illustrated by Example 3. When the aluminum source is aluminum metal, such as pellet or ingot, aluminum hydroxide or bauxite, a higher temperature of greater than 90° C. is applied. When aluminum powder is used in Method A, insoluble materials, such as alumino-silicate by-products, are not generated. Hereinafter Method A will be sometimes referred to alternatively as a “clean process”.

In Method B, bauxite, aluminum hydrate, or aluminum metal, and calcium aluminate and hydrochloric acid are reacted at higher temperature and/or elevated pressure for a certain period of time and the reaction mixtures are filtered to give clear solutions. In this method, aluminum bauxite, calcium aluminate and hydrochloric acid aqueous solution are reacted at above about 90° C. for 8 hours to 12 hours, the reaction mixture is cooled and settled, the top layer of the mixture is separated and filtered to give a clear solution. Any sludge generated as by-products in the process can be used as land refill after repeated washing with acid and water. Alternatively, calcium aluminate can be reacted with hydrochloric acid first, the reaction mixture is filtered to give a clear solution, which is then reacted with aluminum powder. The use of calcium aluminate provides a more economical aluminum source in Method B.

An acid such as hydrochloric acid or aluminum chloride, or an acidic aluminum reagent having a general formula of AlCa_{χ}(OH)_{3+2χ-m}Clₘ, wherein m≧1 and 1≧χ≧0, is added to the reaction products formed either by method A or B. The basicity of the final PAC-Ca solution is determined by the amount of the acid used. It is preferable to use aluminum chloride or hydrochloric acid for the acidification when PAC-Ca is used for antiperspirant applications, whereas any suitable acid may be used when the reaction product is for water treatment and paper sizing applications. The addition of acid is preferably conducted at ambient temperature.

The aluminum polymer distribution and performance of the resulting PAC-Ca produced is determined by the concentrations of calcium, aluminum, and chloride as well as by the nature of the process. Where the calcium content is low, such as about 1% by weight or lower, the basicity of the resultant solution is too low to form the large polymeric aluminum species characterized by Band I of SEC-HPLC. By contrast, if the calcium content is too high, such as greater than about 4%, the basicity of the resultant solution tends to become too high to be stable, resulting in gelling or precipitation. The concentration of the aluminum is also important. For example, if the aluminum concentration is too high, e.g., above about 8.5% by weight, less of the desired Band I polymeric aluminum species is produced, while if the aluminum concentration is too low, e.g., below about 5%, it may be uneconomical to use the product solution. In addition, the Al/Cl ratio influences the stability of the product. For example, if the ratio is too low, such as below about 0.5, more basic calcium salt is required in order to achieve the desired basicity for the formation of the large Band I aluminum species a condition which would result in an unstable solution, partially due to the higher ionic strength of the solution. Ultimately, it is preferable to have a PAC-Ca solution containing about 1.5% to about 3.5% Ca, and preferably about 2% to about 3% Ca; about 5.5% to about 8.5% Al, and preferably about 6.5% to about 7.5% Al; about 0.5:1 to about 1:1 Al/Cl atomic ratio, and preferably a ratio of about 0.6:1 to about 0.9:1. The PAC-Ca or any intermediate solutions can be dried to powders by any known suitable means, including drum drying, spray drying, freeze drying and vacuum drying.

As noted hereinabove, basicity is used to express the degree of neutralization or hydrolysis of PAC solutions. The basicity of the PAC solution is defined as % Basicity={[OH⁻]/(3[Al³⁺])}×100. Commercial polyaluminum coagulants are generally available with basicities ranging between about 15% and about 85%. The basicity affects the alkalinity consumption of the coagulant, as well as the relative prevalence of polymeric and monomeric aluminum species. In general, higher basicities result in greater amounts of polymerized aluminum species whereas a larger fraction of depolymerized (such as Band IV) aluminum species results in products of lower basicity. It has been found that the novel PAC-Ca solutions prepared according to the present invention have both large amounts of depolymerized aluminum species (Band IV), and of higher molecular weight aluminum species (Band I). There is no substantial amount of Al_{b} (Al₁₃-mer) contributed to the enhanced performance of the PAC solution for water treatment in the novel PAC-Ca solutions of the present invention, as demonstrated by Example 3.

The novel polyaluminum calcium hydroxychloride compositions of the present invention are characterized as follows:

### SEC-HPLC

The degree of the polymerization of aluminum complexes is determined by Size Exclusion Chromatography (SEC) operated via a High Performance Liquid Chromatograph (HPLC) instrument described, for example, in U.S. Pat. Nos. 5,330,751 and 5,356,609. In this technique, Al polymer distributions are separated according to their molecular weights, and described as Bands I, II, III, and IV in order of decreasing molecular weight: Band I has the largest molecular weight aluminum species, the intermediate molecular weight aluminum species are described as Bands II and III, and Band IV contains the aluminum species having the lowest molecular weight, such as aluminum monomers and dimers. Bands V and VI are derived from calcium and chloride. The relative area of one or more peaks is determined in order to characterize the distribution of polymeric species in the aluminum complexes that are formed. All the aluminum species are eluted in Bands I, II, III and IV and the percentage of each peak area is calculated accordingly. It is generally preferred to have more depolymerized aluminum species such as high SEC-HPLC Bands III and IV in aluminum or aluminum-zirconium antiperspirant salts in order to have enhanced efficacy for antiperspirant applications. The novel PAC-Ca compositions according to the present invention have SEC-HPLC Band I peak area of about 5% to about 40% and Band IV peak area of about 20% to about 90%. It is preferable to have less than 20% Band I and most preferably, less than 10% Band I and more than about 40% Band IV when the reaction products are used as antiperspirants. When used as a water treatment chemical it is preferable to have more than 20% and generally more than 25% Band I and more than 30% and preferably, more than about 35% peak area in Band IV.

### Nuclear Magnetic Resonance Spectroscopy

²⁷Al Nuclear Magnetic Resonance (NMR) is utilized to identify the structures and/or coordination environments of aluminum containing solutions and materials. This technique has been applied in the current invention for the different aluminum species in the novel PAC-Ca compositions. The PAC-Ca in solution form is measured as is and the powder is dissolved in deuteriated water to form a 10% by weight solution just before the measurement. Data were collected using a Varian Inova 400 instrument at 104.2 MHz.

The invention will be further illustrated by the following examples. In the examples, parts are by weight unless otherwise specified. The examples are intended to be illustrative and should not be construed as placing a limitation on the scope of the invention.

### EXAMPLE 1

### Preparation of PAC-Ca Solutions by the Addition of Aluminum Chloride to the Reaction Product—Process A

191 parts of aluminum chloride was mixed with 269 parts of water, which was heated to 80° C. to 90° C., 20 parts of calcium oxide (99% purity) was added and reacted to form a clear solution, followed by the addition of aluminum powder. The reaction was finished in 1.5 hours. After filtration a clear colorless solution was obtained with 6.03 % Al, 3.0% Ca and 8.9% Cl. Different amount of aluminum chloride solutions were added to the above clear solution to make PAC-Ca solutions with different Al/Cl ratios and basicities. The results are listed in Table I.

TABLE I

| Experiment | Al/Cl | | | | | |
|---|---|---|---|---|---|---|
| Number | Ratio | % Al | % Ca | % Basicity | % Band I | % Band IV |
| 1 | 0.5 | 5.78 | 1.56 | 45.5 | 5.0 | 81.7 |
| 2 | 0.6 | 5.87 | 2.10 | 60.5 | 13.2 | 66.0 |
| 3 | 0.7 | 5.94 | 2.48 | 71.0 | 23.4 | 48.4 |
| 4 | 0.8 | 5.98 | 2.73 | 77.7 | 30.4 | 31.1 |

Note:
The larger polymeric aluminum species as indicated by Band I of the PAC-Ca solutions have been found to be more stable at higher basicity in the presence of aluminum chloride. Further higher amount of Band IV aluminum species are produced at a basicity greater than 70%.

### EXAMPLE 2

### Preparation of PAC-Ca Solutions by Addition of Aluminum Chloride to the Reaction Product—Process B

Different aluminum chloride solutions were added to the solutions of the reaction products, which was prepared by mixing and heating aluminum bauxite, calcium aluminate and hydrochloric acid aqueous solution at about 100° C. for desired time period, cooling, settling, filtering and drying. The results of the resulted PAC-Ca solutions are summarized in Table II.

TABLE II

| Experiment | Al/Cl | | | | | |
|---|---|---|---|---|---|---|
| Number | Ratio | % Al | % Ca | % Basicity | % Band I | % Band IV |
| 5 | 0.50 | 7.0 | 2.66 | 50.5 | 5.4 | 86.5 |
| 6 | 0.60 | 7.0 | 2.73 | 61.9 | 16.3 | 60.8 |
| 7 | 0.70 | 7.0 | 3.25 | 72.9 | 27.0 | 32.6 |
| 8 | 0.76 | 7.0 | 3.46 | 78.0 | 33.6 | 31.3 |

### EXAMPLE 3

### Comparison of PAC-Ca Solutions Made by Addition of Acidic Aluminum Solution to the Reaction Products According to Process A at Both High and Low Temperatures

(i) Preparation of Acidic Aluminum Solution

785 parts of aluminum chloride solution was mixed with 183 parts of water and heated. 32 parts of aluminum powder was added and reacted at 90° C. to 95° C. for about 1 hour. The reaction mixture was filtered to give a clear solution, which contains 7.6% Al and 17.5% Cl with Al/Cl ratio of 0.57.

(ii) Preparation of PAC-Ca Solutions at Low Temperature

106 parts of aluminum chloride, 123 parts of water and 8.75 parts of calcium oxide were mixed and refluxed for 1 hour to give an almost clear solution, which was then cooled to about 55° C. and aluminum powder was added at that temperature in about 40 minutes and reacted at 55° C. to 70° C. for 6.5 hours. The reaction mixture was filtered. 100 parts of such solution was mixed with 17 parts of acidic aluminum solution prepared by reaction (i) to give a clear colorless PAC-Ca solution (experiment number 9).

(iii) Preparation of PAC-Ca Solutions at High Temperature

474 parts of aluminum chloride, 500 parts of water and 44 parts of calcium oxide were reacted at 85° C. to 90° C. until almost clear, 47 parts of aluminum powder was added and reacted for about 1 hour and 40 minutes. Water was added during the reaction to maintain the volume of the solution. 200 parts of the filtered solution was mixed with 32 parts of solution (i) to form a clear colorless PAC-Ca solution (experiment number 10). The results are summarized in Table III

TABLE III

| Experiment | Al/Cl | | | | | |
|---|---|---|---|---|---|---|
| Number | Ratio | % Al | % Ca | % Basicity | % Band I | % Band IV |
| 9 | 0.90 | 7.4 | 2.12 | 75.8 | 24.4 | 34.7 |
| 10 | 0.85 | 7.3 | 2.65 | 77.0 | 33.4 | 34.3 |

Note:
Both solutions 9 and 10 have low Al^{b} of 11.4% and 8.6% respectively.

Solutions 9 and 10 were used for jar testing to compare with two PAC solutions (both are available commercially). PAC-1 solution has a high HPLC Band I and low Band IV of less than 10% with basicity above 82%. PAC-2 solution has no Band I and high Band IV of over 35% with basicity of about 75%. Both PAC-1 and PAC-2 solutions have above 11% Al by weight. Jar tests were conducted with the initial turbidity of the water being 14 NTU. During the test, the coagulants were mixcu with test water and agitate at 100 RPM for 1 minute, followed by slow mixing (30 RPM) for 10 minutes and very slow mixing (15 RPM) for 10 minutes for floc settling and the data are illustrated in Table IV.

TABLE IV

| Experiment | Dose | Turbidity | Sludge | Al Level |
|---|---|---|---|---|
| Number | (ppm) | (NTU) | (#/MMG) | (mM/L) |
| PAC-1 | 30 | 4.98 | 87.93 | 0.1352 |
| PAC-2 | 30 | 1.11 | 87.93 | 0.1352 |
| 9 | 25 | 1.03 | 44.28 | 0.0681 |
| 10 | 25 | 0.91 | 43.97 | 0.0676 |

The data indicate that PAC-Ca solutions outperformed or performed equally as PAC solutions at much lower aluminum content. Further much less sludge was generated by PAC-Ca solutions.

### EXAMPLE 4

### Preparation of PAC-Ca Solutions According to Process B

(i) Preparation of Mid-Basicity PAC-Ca Solution

536 parts of HCl solution was added to 150 parts water in a reaction vessel and mixed thoroughly. 210 parts of calcium aluminate (27.8% Al, 19.2% Ca) was added in 30 min., resulting in an exotherm to 110° C. of the reaction mixture. The temperature was maintained for 1.5 hrs and the resulting slurry filtered, giving a clear, brown-colored solution with at 5.45% Al (10.3% Al₂O₃) and a bascity of 39%.

(ii) Preparation of High Basicity PAC-Ca Solution

200 parts of the 39% basic PAC-Ca solution was mixed with 360 parts water and heated. 32 parts aluminum powder was added over a designated period of time. After addition, the reaction was continued until full dissolution of Al powder. After dissolution, 178 parts of the 39% PAC-Ca solution was added to the reaction mixture and then filtered, providing a 6.98% Al (13.2% Al₂O₃) solution at 77% basicity.

It will be understood that the present invention is susceptible to numerous changes and modifications as apparent to those skilled in the act. Accordingly, the present invention may be embodied in other specific forms without departing from the spirit of essential attributes of the invention disclosed herein and reference should be made to the appended claims, in the light of the foregoing specifications, as indicating the scope of the invention.

What is claimed is:

1. A process for manufacturing a PAC-Ca solution of the formula:
AlₙCaₓ(OH)_{3n+2χ-m}Clₘ
wherein n is the mole of aluminum, χ is the mole of calcium and m is the mole of chloride and wherein the ratio of aluminum to chloride of the solution is from about 0.5 to about 1.0 and basicities ranging from about 40% to about 80% with HPLC Band I peak area of 5% to 40% and Band IV peak area of 20% to 90% through the acidification of the reaction products prepared by:
(A) (i) reacting an aqueous acid solution selected from hydrochloric acid and aluminum chloride with a strong calcium base; and
(ii) reacting the solution from (i) with an aluminum source at a temperature of at least 60° C. until a stable product solution is obtained; and
(B) (i) reacting an aluminum compound selected from aluminum metal, bauxite, aluminum hydrate with calcium aluminate and a strong acid at an elevated temperature above about 90° C. for a period of time sufficient to yield a stable reaction product;
(ii) cooling and settling the reaction product mixture; and
(iii) separating and filtering the supernatural layer of the reaction mixture to obtain a clear stable solution.

2. A process for manufacturing a PAC-Ca solution of the formula:
AlₙCaₓ(OH)_{3n+2χ-m}Clₘ
wherein n is the mole of aluminum, χ is the mole of calcium and m is the mole of chloride and wherein the ratio of aluminum to chloride of the solution is from about 0.5 to about 1.0 and basicities ranging from about 40% to about 80% with HPLC Band I peak area of 5% to 40% and Band IV peak area of 20% to 90% through the acidification of the reaction product prepared by:
(i) reacting an aqueous acid solution selected from hydrochloric acid and aluminum chloride with a strong calcium base; and
(ii) reacting the solution from (i) with an aluminum source at a temperature of at least 60° C. until a stable product solution is obtained.

3. A process for manufacturing a PAC-Ca solution of the formula:
AlₙCaₓ(OH)_{3n+2χ-m}Clₘ
wherein n is the mole of aluminum, χ is the mole of calcium and m is the mole of chloride and wherein the ratio of aluminum to chloride of the solution is from about 0.5 to about 1.0 and basicities ranging from about 40% to about 80% with HPLC Band I peak area of 5% to 40% and Band IV peak area of 20% to 90% through the acidification of the reaction products prepared by:
(i) reacting an aluminum compound selected from aluminum metal, bauxite, aluminum hydrate with calcium aluminate and a strong acid at an elevated temperature above about 90° C. for a period of time sufficient to yield a stable reaction product; and
(ii) cooling and settling the reaction product mixture; and
(iii) separating and filtering the supernatural lay of the reaction mixture to obtain a clear stable solution.

4. The process of claim 1 wherein the acid used in the acidification is aluminum chloride.

5. The process of claim 1 wherein the acid used in the acidification is hydrochloric acid.

6. The process of claim 2 having an HPLC Band I peak area of less than 10% and a Band IV peak area of more than about 40%.

7. The process of claim 3 having an HPLC Band I peak area of more than 20% and a band IV peak area of more than about 30%.

8. The method of claim 2 wherein the aluminum source is aluminum powder.

9. The method of claim 2 wherein the aqueous acid solution comprises hydrochloric acid.

10. The method of claim 2 wherein the aqueous acid comprises aluminum chloride.

11. The method of claim 2 wherein the composition has an HPLC Band I peak area of at least 20% and Band IV of at least 30%.

12. The method of claim 2 wherein the solution is dried to a solid.

13. The method of claim 3 wherein the aluminum compound is bauxite.

14. The method of claim 3 wherein the calcium source is calcium aluminate and the strong acid is hydrochloric acid.

15. The method of claim 3 wherein the aluminum compound is aluminum metal.

16. The method of claim 3 wherein the aluminum compound is aluminum hydrate and the strong acid is aluminum chloride.

17. The method of claim 3 wherein the composition has an HPLC Band I peak area of more than 20% and Band IV of more than 30%.

18. The method of claim 3 wherein the solution is dried to a solid.

19. The product obtained by the method of claim 2.

20. The product obtained by the method of claim 3.
